(19) United States
(12) Patent Application Publication
(10) Pub. No.: US 2002/0092363 A1
(43) Pub. Date: Jul. 18, 2002

(54) Contactless resistive heater for liquids in microenvironments and related methods

(76) Inventors: James W. Jorgenson, Chapel Hill, NC (US); Keith E. Fadgen, Chapel Hill, NC (US); Luke T. Tolley, Chapel Hill, NC (US)

Correspondence Address: JENKINS & WILSON, PA, 3100 TOWER BLVD, SUITE 1400, DURHAM, NC, 27707, US

(21) Appl. No.: 09/875,697

(22) Filed: Jun. 6, 2001

Related U.S. Application Data
(63) Continuation-in-part of application No. 09/760,919, filed on Jan. 16, 2001.

(51) Int. Cl. G01F 1/708

(52) U.S. Cl. 73/861.95

(57) ABSTRACT

A contactless, resistive heating device applies heat energy non-invasively to a target zone of liquid contained by a non-conductive substrate or capillary. The heating device supplies an AC signal to two spaced-apart electrodes, which are disposed externally of the substrate. A circuit is established in which the source of the AC signal is capacitively coupled with the liquid through each electrode. The zone of liquid between the electrodes is heated due to the resulting flow of electrical current across the zone.

### CROSS-REFERENCE TO RELATED APPLICATIONS

This is a continuation-in-part of U.S. patent application Ser. No. 09/760,919, filed Jan. 16, 2001, and now pending, the entire contents of which are herein incorporated by reference.

### TECHNICAL FIELD

The present invention relates generally to heating liquids or small portions of liquids flowing through fluid conduits. More specifically, the present invention relates to non-invasive heating of such liquids or portions of liquids through the use of a contactless device, and further relates to applications benefiting from this non-invasive, contactless heating process.

### BACKGROUND ART

Capillaries and/or containers constructed from fused silica, polymers and other types of small-diameter tubes or reservoirs are utilized by scientists and researchers for a variety of purposes. One example is the performance of chemical separations for analytical purposes such as liquid chromatography. As will be appreciated by those skilled in the art, there exists a need to be able to selectively and accurately heat small amounts of liquid flowing or residing inside small capillaries and reservoirs. In particular, these localized heating processes are useful in many applications relating to the chemical, biological and biochemical fields. For instance, many chemical reactions require the input of heat energy to proceed or occur much more rapidly at elevated temperatures, especially when reaction kinetics are dependent upon temperature. Additionally, it is often desirable to be able to reduce the viscosity of liquids, and the input of heat energy is an easy way to accomplish such reduction.

Current heating methods, however, are considered to be inadequate with regard to selectivity and accuracy, and thus is it recognized that there is room for improvement. For example, heating of small capillaries and/or reservoirs has been accomplished by using a conventional external heating element, such as a resistive strip or inductive coil, to apply heat energy to the substrate (such as the outside walls or volume-defining boundaries of a conduit, reservoir and the like) containing a given liquid. Even if the external heating element is situated in close proximity to the zone of liquid in the capillary to be heated, the external application of heat energy does not result in a sufficiently localized heating effect. This disadvantage is due in part to the fact that the externally applied heat energy must first be transferred through the material constituting the substrate or liquid conduit, in accordance with the principles describing the mechanism of heat transfer by conductive mode. It is quite difficult to prevent the heat energy being applied to the substrate or conduit wall from diffusing through a section of the material of the wall itself prior to being transferred to the intended target (i.e., the zone of liquid to be heated). The diffusion of heat energy through the substrate can result in substantial losses of the energy input intended for use in heating the liquid itself, as well as the heating of unintended zones of liquid outside the boundaries of the intended target zone. Therefore, in cases where it is often desirable to heat a very small region or zone of the liquid and not the liquid surrounding this region or zone, the externally applied heating process is unsatisfactory due to the ensuing heat diffusion through the substrate.

In addition, since the heat energy is applied to the substrate instead of directly to the liquid, the process of heating by conventional external means has a slow response time. This is because the substrate itself must first heat up before the liquid is able to do so, thereby increasing the amount of time required to actually heat up the liquid sample in the capillary or reservoir. For instance, the substrate must be heated to a temperature sufficiently high so as to create a temperature gradient by which the heat energy can be transferred to the liquid at an acceptable heat transfer rate. Likewise, the amount of time the sample takes to cool off is greatly increased in most cases due to the large heat capacity of the material constituting the substrate compared to the heat capacity of the liquid. Hence, this limitation does not allow the externally applied heat to have a very rapid effect on the temperature of the liquid.

Another known method for selectively heating a region of liquid contained in a capillary, reservoir or container involves the use of an external source of infrared or other electromagnetic radiation that is focused on the area to be heated. This method is able to provide somewhat localized heating, but is more expensive and complicated in that an external light source is required. In addition, as in the case of the external heating device just described, the external light source often heats the substrate as well as the liquid, due to the fact that light absorption occurs in both the substrate and the liquid.

A further approach might involve placing some type of heating element directly into the conduit containing the liquid, so that the heating element directly contacts the liquid. This approach, however, is by necessity invasive in nature and has several disadvantages. For example, the presence of the heating element might impair the flow of the liquid or alter the fluid dynamics within the conduit in an undesirable manner. Moreover, depending on its design, the heating element might cause undesirable electrochemical or photochemical effects, or might introduce impurities into the conduit.

As discussed in applicants' copending U.S. patent application Ser. No. 09/760,919, there exists a further need to be able to monitor and/or control very low flow rates in real time inside of capillaries and small tubes in order to improve reproducibility in experimentation and analysis, and to troubleshoot problems commonly arising in these types of conduits. Standard techniques for measuring flow in large tubes are not applicable to smaller-scale tubes such as capillaries with low flow rates.

Several methods presently exist for measuring flow rate in capillaries, including time-of-flight flow monitoring with solvent additive, thermal time-of-flight flow monitoring with refractive index detection, and end-of-column solvent collection. Each of these conventional approaches suffers from drawbacks.

Time-of-flight flow monitoring with solvent additive does have several good characteristics. This technique can provide real-time measurements and, in certain implementations, does not require capillary modifications. There are, however, several disadvantages which limit the usefulness of this technique. First, it requires that a marker chemical be added to the solvent. Although this type of chemical is selected to interfere as little as possible with the analytes present in the column and with the chemistry occurring therein, it is impossible for the chemical additive to have no interference at all. The extra chemical present can also interfere with detection methods, especially mass spectrometry, a technique which is gaining in popularity as a detection method for microcolumn separations. The marker chemical can interfere with the ionization process and thus reduce the sensitivity of the detector. It is also likely that the marker chemical shows up in the mass spectra to give extra, unwanted peaks. Moreover, such solvent additives are typically detected by fluorescence measurements or other optical techniques, all of which are expensive and require precise alignment.

Thermal time-of-flight monitoring using a refractive index detector is a viable technique which meets many of the requirements for an ideal microcolumn flow sensor, but again there are several disadvantages to employing this method. A refractive index detector is a complex device which requires precise optical alignment, thus making it impractical for routine use. In addition, this technique often requires capillary modification in the form of an optical window for the refractive index detector. The technique has not been shown to perform with changing solvent conditions, such as a solvent gradient, since every solvent change also changes the refractive index. Moreover, the technique has not been shown to function at the low flow rates commonly encountered in capillary separation processes.

The technique of post-column collection of samples can be used to measure flow rate by weighing the liquid eluting from the tube. This procedure, however, is difficult to perform with small capillaries due to the extremely low flow rates and rapid solvent evaporation. Since this is a post-column technique, it cannot be used with post-column detectors such as mass spectrometry. The technique does not provide good real-time information, since a significant amount of solvent from the column must be gathered before the measurement can be obtained.

An ideal method for measuring flow rate in capillaries and other small tubes has the properties of being simple, not requiring capillary modification, not requiring solvent additives, giving real-time measurements, and being compatible with advanced separation and detection techniques such as those employed in mass spectrometry. Accordingly, the desirability of such improvements over existing flow metering technology can be readily appreciated by those skilled in the art.

The present invention is provided to solve these and other problems associated with the prior technology. As described hereinbelow, the present invention is characterized in part by its use of a contactless electrical device that serves as a resistive heating device. This contactless resistive heating device can be employed in combination with a conductivity detector to create a liquid flow measurement device. Preferably, the conductivity detector has a similar contactless design, as disclosed in applicants' copending U.S. patent application Ser. No. 09/760,919. In this manner, many embodiments of a flow measurement device based on the present invention can be entirely non-invasive with respect to the conduit through which the measured liquid flows. The contactless resistive heating device can further be employed in combination with a freezing device such as a rapid cooling unit to create a phase-changing “liquid valve” for use in controlling flow through fluid conduits.

The use of contactless conductivity detectors in conjunction with capillary electrophoresis has been disclosed by Zemann et al. in “Contactless Conductivity Detection for Capillary Electrophoresis,” Analytical Chemistry, Vol. 70, No. 3, Feb. 1, 1998, pp. L3-L7, in which cationic and anionic compounds are detected after capillary electrophoretic separation; by Fracassi da Silva et al. in “An Oscillometric Detector for Capillary Electrophoresis,” Analytical Chemistry, Vol. 70, No. 20, Oct. 15, 1998, pp. 4339-4343, in which an oscillometric detection cell is developed; and by Mayrhofer et al. in “Capillary Electrophoresis and Contactless Conductivity Detection of Ions in Narrow Inner Diameter Capillaries,” Analytical Chemistry, Vol. 71, No. 17, Sep. 1, 1999, pp. 3828-3833, in which the detector disclosed by Zemann et al. is further developed.

The use of freeze-thaw switching points to manage liquid flow in the context of microanalytical and micro-preparative procedures such as CE, high-performance liquid chromatography (HPLC) and electrochromoaography, has been disclosed in U.S. Pat. Nos. 5,795,788 and 6,159,744. In these patents, freeze-thaw switching points are provided in outlet capillary columns that branch off from a CE column, as well as in micro-channels formed in a micro-chip. Rapid freezing and rapid thawing are alternately effected at the switching points of such conduits to respectively stop and allow liquid flow. The means disclosed for freezing and thawing are conventional, externally sourced means. Rapid freezing is accomplished either by (1) directing a jet of cold gas (e.g., by supplying a source of pressurized, liquefied gas such as liquid carbon dioxide or liquid nitrogen) to the section of the conduit corresponding to the switching point; or by using thermoelectric means such a Peltier cooling device or a cold finger. Rapid thawing is accomplished by directing a jet of warm air to the same section of conduit or, if the normal environmental temperature is sufficiently high, by simply allowing the frozen section to thaw without the aid of a warming device.

### DISCLOSURE OF THE INVENTION

According to one embodiment of the present invention, a contactless resistive heating device is provided. The heating device is designed to selectively heat small amounts of liquid inside of fused silica capillaries or other non-conductive fluid reservoirs without making electrical contact with the liquid itself. As described more fully hereinbelow, the heating process made possible by the heating device of the present invention is accomplished through a combination of capacitive coupling of an AC current and resistive heating of the liquid. The heating device achieves these effects by including at least two electrodes that are placed adjacent to the region or zone of liquid to be heated, yet externally with respect to the substrate containing the liquid, and by applying an alternating current to the two electrodes. With correct placement and design of the electrodes, the applied alternating current will be capacitively coupled through the wall separating the liquid from the electrode and into the liquid itself. The electrical current will be conducted through the liquid to the region near the second electrode, at which point the current will be capacitively coupled out through the wall. A resistive drop occurs when the AC current is conducted through the liquid. This resistive drop in effect causes the liquid in the area through which the current flows to heat up. Moreover, by controlling the amplitude of the applied AC current and the length of time that the current is applied, the amount of heat delivered to the liquid can be accurately controlled. In addition, the temperature of the liquid can be determined from the values of the voltage being applied and the current flowing through the liquid, in accordance with known principles.

Broadly stated, one aspect of the present invention meets the need for accurate and selective (i.e., localized) heating of a zone or portion of liquid flowing through or contained by a substrate. A heating device provided in accordance with the present invention, as described more fully below, includes a contactless resistive heating device. This heating device is able to selectively heat small portions of liquid without having to make physical contact with the liquid. Moreover, the inventive heating device delivers the majority of the heat energy it generates directly to the liquid instead of through the substrate. Most of the heating occurs within the liquid, and very little heat is generated within the material of the substrate surrounding the liquid. As a result, the heating device allows for more accurate control over the temperature of the liquid and that portion of the liquid which is heated by the device. The selectivity of the heating device also allows for more rapid heating and cooling of the liquid because the substrate itself does not need to change temperature. As regards rapid cooling, since the substrate itself does not appreciably become heated as a result of the operation of the heating device, a sufficiently large temperature differential will remain between the heated liquid and the substrate such that the heat energy added to the liquid is rapidly transferred to the substrate.

As will become evident from the description below, the contactless resistive heating device provided in accordance with the present invention substantially only heats that portion of the liquid present between two spaced-apart electrodes provided by the heater device. This arrangement enables accurate control of the area or zone of the liquid intended to be heated. Furthermore, the heating device does not depend on the use of an external light source or related optics-type components, and therefore is relatively inexpensive. Additionally, the heating device is completely electrical in nature, and thus can be integrated into a single electrical component if desired.

According to one embodiment of the present invention, a contactless resistive heating device comprises a substantially non-conductive substrate containing a liquid, an AC signal source, and at least two electrodes disposed externally in relation to the substrate and axially spaced at a distance from each other. Each electrode electrically communicates with the AC signal source. Upon application of an AC signal to the electrodes by the AC signal source, the AC signal source becomes capacitively coupled with the liquid contained by the substrate, thereby causing an electrical current to flow in a zone of the liquid generally disposed between the electrodes.

According to another embodiment of the present invention, a microfluidic device is adapted to heat a small zone of liquid contained in a fluid channel. The microfluidic device comprises a substrate and a fluid channel containing a liquid. The fluid channel is formed on the substrate and includes a substantially non-conductive wall. At least two electrodes are disposed externally in relation to the fluid channel, and are axially spaced at a distance from each other. Each electrode electrically communicates with an AC signal source, which is capacitively coupled with the liquid contained by the fluid channel. Application of an AC signal to the electrodes by the AC signal source causes an electrical current to flow in a zone of the liquid generally disposed between the electrodes.

According to one method of the present invention, a targeted zone of liquid contained by a substrate is non-invasively and resistively heated. At least a first electrode and a second electrode are placed externally in relation to a substrate containing a liquid. The first and second electrodes are axially spaced apart from each other in relation to a length of the substrate, thereby generally defining a zone of the liquid between the first and second electrodes. The zone of liquid is heated by applying an AC signal to the first and second electrodes, whereby the AC signal is capacitively coupled from the first electrode into the liquid, an electrical current flows through the zone of liquid, and the AC signal is capacitively coupled out from the liquid to the second electrode.

The novel heating device also can be used to denature proteins or DNA. In one specific application, the heating device is used as part of the important polymerase chain reaction (PCR), a DNA amplification reaction that is very useful in fields ranging from medical diagnostics, genetic engineering, molecular evolution, to forensic science. As appreciated by persons skilled in the art, the speed at which PCR can be performed is limited mainly by the rate at which DNA can be safely denatured by application of one or more heating cycles to the sample. By way of example, one step of the reaction is performed at approximately 90° C. while another step is often performed at approximately 60° C. The rate at which the liquid can be brought to these temperatures is currently a speed limiting step in the process. For a typical PCR process in which 25 or 30 heating cycles are performed, the process can take one or more hours even though it is automated. In accordance with the present invention, however, the heating device is employed in carrying out the heating steps required. Because the heating device heats the liquid directly without imparting much heat to the substrate, the thermal cycling can be accomplished much more rapidly, thereby allowing the reaction to proceed faster.

Therefore, according to another method of the present invention, the polymerase chain reaction is performed in which a liquid includes double-stranded DNA, oligonucleotide primers, nucleotide triphosphates, and a DNA polymerase. This liquid is contained by a substantially non-conductive substrate. A contactless resistive heating device as disclosed herein is used to raise a temperature in a zone of the liquid containing the DNA.

According to yet another method of the present invention, the polymerase chain reaction is performed by providing a contactless resistive heating device. The heating device includes an AC signal source and at least two electrodes disposed externally in relation to the substrate, wherein each electrode is axially spaced at a distance from the other electrode and electrically communicates with the AC signal source. The double-stranded DNA is denatured to generate single-stranded DNA by causing the AC signal source to apply an AC signal to the electrodes. Consequently, the AC signal becomes capacitively coupled with the liquid contained by the substrate. An electrical current flows in a zone of the liquid that is generally disposed between the electrodes and contains the DNA, and the zone becomes heated to a denaturing temperature. The temperature of the liquid is lowered to permit hybridization of the primers. The temperature of the liquid is adjusted to a extending temperature sufficient to permit extension of the primers by the DNA polymerase. This process can be cycled a number of times to obtain the desired degree of amplification of the target DNA sequence. Besides the denaturing steps, the heating device can further be used to control or adjust the temperature of the liquid to execute one or more of the other steps generally required in performing the polymerase chain reaction.

In other embodiments, the present invention is provided to meet the need for accurate flow metering in fused silica capillaries, polymer capillaries and other small tubes or channels in which low flow rates typically occur, and to meet the ideal criteria delineated hereinabove. The present invention therefore provides an apparatus for measuring low flow rates in capillaries in real time, without any modification to the capillary itself and without the need for solvent additives. The measuring apparatus provided in accordance with the present invention is compatible with most known detectors, including post-column detectors such as mass spectrometry. The real-time measurement of flow rate performed by the present invention enables real-time control of flow rate, thereby obtaining better results and reproducibility than heretofore known.

Since the flow monitoring device provided by the present invention does not require optical components, it can be made smaller than other types of monitoring devices. The device can be made small enough to be integrated onto a microchip if desired. The device requires no precise alignment or expensive components, thus rendering the device more robust and inexpensive in comparison to devices which require optics. Moreover, the device according to the present invention does not depend as heavily on the internal diameter of the capillary as do devices which rely on optical methods.

As will be appreciated by those skilled in the art, the real-time monitoring provided by the present invention of flow rate in capillaries or other small-diameter tubes is important for reproducibility, and allows a feedback system which can maintain a constant flow rate even with varying solvent and/or temperature conditions. The capabilities provided by the present invention allow for faster, more reproducible separations and make some separation techniques more practicable. One example is capillary electrophoresis (CE). CE has become fairly common in the past few years, but many persons skilled in the art have cited poor reproducibility as a deterrent to switching from liquid chromatography or other methods. The poor reproducibility observed by those skilled in the art is due mainly to ambient temperature fluctuations which cause a change in flow rate. The flow metering device provided in accordance with the present invention, however, allows for much greater reproducibility by either adjusting the flow rate through feedback or by simply informing the user of the current flow rate so that an adjustment can be made.

In one exemplary implementation, an instrument provided in accordance with the present invention can be utilized as a stand-alone device for measuring flow rate in capillaries or other small tubes such as capillary chromatography columns. The present invention can successfully function in conjunction with fused silica capillaries, polymer capillaries as well as other non-conductive tubing.

In another implementation, the device according to the present invention can be integrated into a system to function as part of a flow rate control loop.

Yet another implementation relates to the current interest in chip-based separations in which “lab-on-a-chip” devices are being developed. A flow sensor provided in accordance with the present invention can be integrated with a micro-fluidic device to monitor flow and provide diagnostics. Because the inventive device can be completely electrical in operative nature, the device can be built into the chip without any external components, thus making the device quite inexpensive and robust.

According to one embodiment of the present invention capable of measuring flow rates, a liquid flow measuring apparatus comprises a fluid conduit including a substantially non-conductive conduit wall, a contactless resistive heating device adapted to raise a temperature of a zone of liquid flowing through the fluid conduit, and a conductivity detection device disposed downstream of the heating device in relation to the conduit wall.

According to another embodiment of the present invention capable of measuring flow rates, the heating device includes an AC signal source and first and second electrodes connected to the AC signal source. The first and second electrodes are disposed externally in relation to the conduit wall and are axially spaced from each other. The AC signal source is capacitively coupled with the liquid flowing through the fluid conduit. Application of an AC signal to the electrodes by the AC signal source causes an electrical current to flow in a zone of the liquid generally disposed between the electrodes.

According to yet another embodiment of the present invention capable of measuring flow rates, a microfluidic device is adapted to measure liquid flow rates. The microfluidic device comprises a substrate, a fluid channel containing a liquid, a contactless resistive heating device, and a conductivity detection device. The fluid channel is formed on the substrate and includes a substantially non-conductive wall. The heating device is adapted to raise a temperature of a zone of liquid flowing through a section of the fluid channel. The conductivity detection device is disposed downstream of the section of the fluid conduit at which the liquid temperature is raised.

According to a related method of the present invention, the rate at which a liquid is flowing through a fluid conduit is measured, in which the fluid conduit includes a substantially non-conductive wall. A contactless, resistive heating device is used to cause a temperature rise in a volume of the liquid disposed in a first section of the fluid conduit. At a second section of the fluid conduit spaced downstream of the first section at a predetermined distance, a change in conductivity is detected in the liquid occurring as a result of the temperature rise.

According to a further embodiment of the present invention capable of measuring flow rates, a liquid flow measuring apparatus comprises a fluid conduit including a substantially non-conductive conduit wall, a rapid cooling device, a contactless resistive heating device, and a conductivity detection device. The rapid cooling device is adapted to freeze a first portion of a liquid flowing through the fluid conduit. The contactless resistive heating device is adapted to add heat energy to a second portion of the liquid proximate to the first portion of the liquid. The conductivity detection device is disposed downstream of the rapid cooling device in relation to the conduit wall. The principles by which the rapid cooling device is capable of causing a perturbation, of a quality detectable by the conductivity detection device, is described in detail in applicants' copending U.S. patent application Ser. No. 09/760,919.

According to a further related method of the present invention, the rate at which a liquid is flowing through a fluid conduit is measured, in which the fluid conduit includes a substantially non-conductive wall. A rapid cooling device is used to freeze at least a portion of a volume of the liquid disposed in a first section of the fluid conduit. A contactless, resistive heating device is used to assist in thawing the portion of liquid subject to freezing by the rapid cooling device. At a second section of the fluid conduit spaced downstream of the first section at a predetermined distance, a change is detected in conductivity in the liquid occurring as a result of the use of at least the rapid cooling device.

According to an additional embodiment of the present invention, the contactless resistive heating device can be combined with a freezing device to form a switching device or gate for controlling liquid flow through a micro-channel formed on a microfluidic chip device. The freezing device can be activated to stop or reduce flow through the section of the micro-channel targeted by the switching device. The heater device can be activated to assist in subsequent thawing of the frozen section in order to cause liquid flow to resume through the micro-channel.

Therefore, according to the present invention, a device for controlling liquid flow through a conduit comprises a fluid conduit including a substantially non-conductive conduit wall, a freezing device, and a contactless resistive heating device. The freezing device is adapted to freeze a first portion of a liquid contained in the fluid conduit. The heating device is adapted to raise a temperature of a second portion of liquid contained in the fluid conduit.

According to a related method of the present invention, liquid flow through a conduit is controlled by stopping the flow of liquid through a targeted section of the fluid conduit, which fluid conduit has a non-conductive conduit wall. The flow is stopped by freezing a first portion of the liquid contained in the targeted section. The liquid is then permitted to flow through the targeted section by activating a contactless resistive heating device. The heating device causes a rise in temperature in a second portion of the liquid adjacent to the frozen first portion, and thereby assists in thawing the frozen portion.

It is therefore an object of the present invention to provide a heating device capable of heating a specific, target portion of a liquid.

It is another object of the present invention to provide a liquid heating device that adds heat energy to the liquid in a contactless, non-invasive manner.

It is yet another object of the present invention to provide a liquid heating device capable of rapidly applying a controlled amount of heat to a controlled zone of liquid contained by a substrate.

It is a further object of the present invention to provide a contactless, resistive heating device that exhibits accuracy and other improved properties, such that the heating device can be employed to improve a wide variety of applications, such as the polymerase chain reaction, that stand to benefit from the enhanced performance of the device.

It is an additional object of the present invention to provide an accurate liquid flow metering and/or controlling apparatus adapted to operate non-invasively on fluid conduits.

It is another object of the present invention to provide a non-invasive flow measuring apparatus which is particularly advantageous in measuring low flow rates typically encountered in capillaries and other small-diameter tubes.

Some of the objects of the invention having been stated hereinabove, other objects will become evident as the description proceeds when taken in connection with the accompanying drawings as best described hereinbelow.

### BRIEF DESCRIPTION OF THE DRAWINGS

FIG. 1A is a schematic diagram of a contactless resistive heating device according to the present invention during operation thereof, illustrating the capacitive coupling of an AC signal to the core of a capillary;

FIG. 1B is a schematic diagram of the device during operation thereof, illustrating the flow of electrical current through the core of the capillary;

FIG. 1C is a schematic diagram of the heating device during operation thereof, illustrating the capacitive coupling of the AC signal out of the core of the capillary;

FIG. 2 is a schematic diagram of an equivalent electrical circuit modeling the heating device illustrated in FIGS. 1A, 1B, and 1C;

FIG. 3 is a topological diagram of a chip or a region thereof in which a contactless resistive heating device is integrated in accordance with the present invention;

FIG. 4 is a schematic diagram of a flow metering apparatus provided in accordance with the present invention;

FIGS. 5A, 5B and 5C are respective, sequential schematic diagrams of the flow metering apparatus illustrated in FIG. 4 during operation thereof;

FIG. 6 is a schematic diagram of the flow metering apparatus illustrated in FIG. 4, illustrating details of components of the contactless resistive heating device and conductivity detection device provided with the flow metering apparatus;

FIG. 7 is a topological diagram of a chip or a region thereof in which a flow measuring apparatus is integrated in accordance with the present invention;

FIG. 8 is a schematic diagram illustrating an application of the present invention providing real-time control of flow rate in a capillary electrophoresis process;

FIG. 9 is a schematic diagram of another flow measuring apparatus provided in accordance with the present invention;

FIG. 10A is a schematic diagram illustrating an example of a phase changing process accomplished by the flow measuring apparatus shown in FIG. 9, in which a burst of cold fluid is applied to a capillary;

FIG. 10B is a schematic diagram illustrating the phase changing process performed by the flow measuring apparatus shown in FIG. 9, in which a portion of the liquid in the capillary freezes and ions are displaced;

FIG. 10C is a schematic diagram illustrating the phase changing process performed by the flow measuring apparatus shown in FIG. 9, in which the frozen portion of the liquid in the capillary melts and results in a zone of lower ionic concentration;

FIGS. 11A, 11B and 11C are respective, sequential schematic diagrams of the flow metering apparatus illustrated in FIG. 9 during operation thereof;

FIG. 12 is a topological diagram of a chip or a region thereof in which a flow metering apparatus, including a rapid cooling device, a contactless resistive heating device and a conductivity detection device, is integrated in accordance with the present invention; and

FIG. 13 is a topological diagram of a chip of a region thereof in which a liquid flow switching device, including a rapid cooling device and a contactless resistive heating device, is integrated in accordance with the present invention.

### DETAILED DESCRIPTION OF THE INVENTION

As used herein, the term “liquid,” such as the liquid to be heated by the devices and methods of the present invention disclosed herein, encompasses virtually any type of liquid-phase containing material, such as a solution consisting of one or more various components (for example, analytes dissolved in a solvent), a suspension, an emulsion, or a flowable gel. Further non-limiting examples of “liquids” include the wide range of flowable materials which persons skilled in the art might encounter in the course of conducting procedures relating to liquid chromatography, mass spectrometry, capillary electrophoresis, as well as processes in which microfluidic devices are or could be employed.

As used herein, the term “substrate” or “capillary” encompasses any structure that can be used to provide one or more boundaries or sides for a liquid, and that can be used to contain, direct the flow of and/or provide a conduit for liquid. Non-limiting examples of substrates and capillaries include containers, reservoirs, tubes, conduits, channels, and microfluidic channels or micro-channels. Some of these substrates or capillaries can be provided in the form of a hollow cylinder, for which an elongate interior is circumscribed by a wall. Embodiments provided in accordance with the present invention can operate in conjunction with substrates and conduits having a wide range of outside and inside diameters. In particular, however, the present invention can be successfully and advantageously applied to small-diameter capillaries. Preferably, the inside diameter of the capillary is approximately 1 mm or less. More preferably, the inside diameter is approximately 0.2 mm or less or, even more preferably, 0.05 mm or less.

The substrate or capillary is constructed from a generally or substantially electrically non-conductive or insulative material, such that the substrate or capillary may be characterized as comprising a dielectric material. By way of example, the material can be fused silica or glass, or have other morphologies typical of ceramic or refractory materials. The material could also be a polymer.

### Heating Devices and Methods

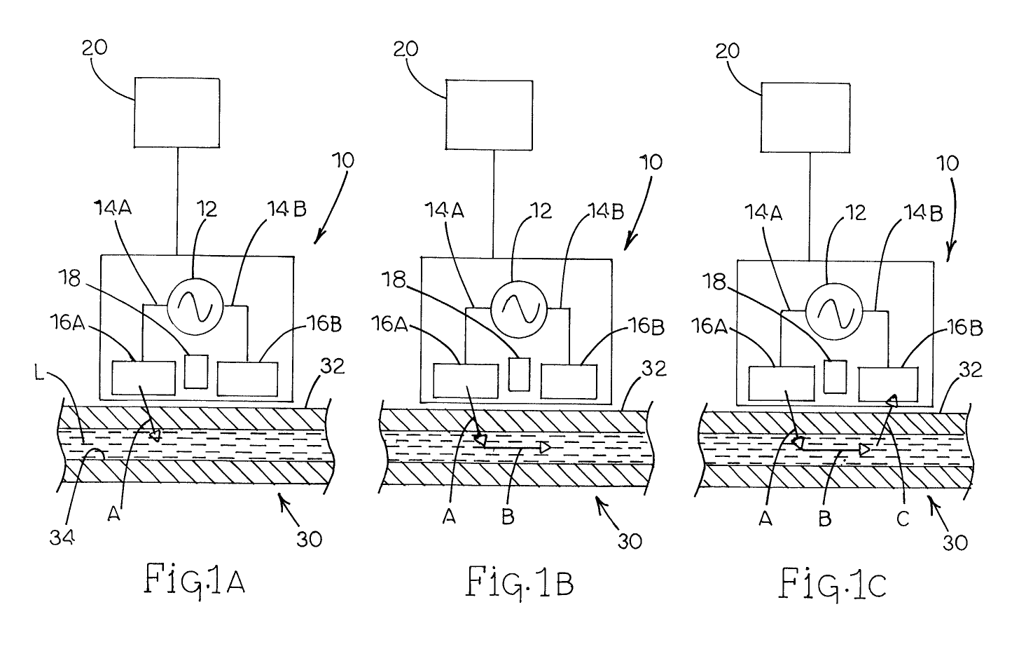

Referring now to FIGS. 1A-1C, a non-invasive, contactless, resistive heating device, generally designated 10, is illustrated in accordance with the present invention. Heating device 10 operates in conjunction with a capillary, generally designated 30, as this latter term is broadly defined hereinabove. In the example provided in FIGS. 1A-1C, capillary 30 includes a capillary wall 32 that defines a generally cylindrical, hollow capillary core 34 through which a liquid L (as broadly defined hereinabove) flows. Heating device 10 generally includes an AC signal source 12 electrically coupled by lead wires 14A and 14B, respectively, to two electrodes 16A and 16B disposed in proximity to each other and mounted adjacent to the outside of capillary wall 32. Electrodes 16A and 16B are spaced at a distance from each other, and preferably are provided in the form of metallic bands or tubes which are coaxially disposed about capillary wall 32. Heating device 10 essentially functions by applying an AC signal to these electrodes 16A and 16B, and by capacitively coupling the AC voltage to conductive solution 36 across the dielectric material which forms capillary wall 32. A shield 18 is preferably interposed between electrodes 16A and 16B to reduce their direct capacitive coupling to each other. In preferred embodiments, shield 18 is constructed from a brass or copper material.

As a result of the design of heating device 10 and the dielectric properties of capillary wall 32, the AC signal is capacitively coupled between electrode 16A and conductive liquid L in capillary core 34. Referring specifically to FIG. 1A, this capacitive coupling is depicted by arrow A. Referring to FIG. 1B, a potential difference is established within capillary core 34 and causes a current to be conducted through liquid L, in the direction generally represented by arrow B. Referring to FIG. 1C, when the current reaches the vicinity of other electrode 16B, the AC signal is capacitively coupled out as depicted by arrow C. As described above, a resistive drop occurs when the AC current is conducted through liquid L. This resistive drop in effect causes liquid L in the area through which the current flows to heat up.

In addition, conventional means, depicted in FIGS. 1A-1C as an electrical device or circuit 20 of known design, can be disposed in interfacing electrical communication with heating device 10. Such device or circuit 20 can be employed to control the amplitude of the applied AC current and the length of time that the current is applied. Consequently, the amount of heat delivered to liquid L can be accurately predetermined and controlled. In addition, the temperature of liquid L can be determined from the values of the voltage being applied and the current flowing through liquid L, in accordance with known principles. It can thus be seen that heating device 10 applies a controlled, localized amount of heat to a targeted zone of liquid L through a combination of capacitive coupling of an AC current and resistive heating of liquid L, but without making electrical contact with liquid L itself.

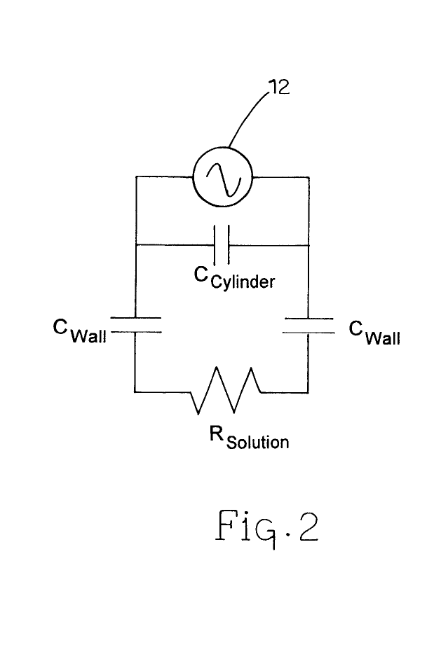

Referring to FIG. 2, the equivalent circuit for heating device 10 is illustrated. AC signal source 12 is placed in parallel with the electrical resistance of the solution flowing through capillary 30 (see FIGS. 1A-1C). This resistance is represented by a resistor R_{Solution}. Given that resistance varies with temperature and is inversely related to conductance, the present invention could be characterized as being adapted to measure the value for resistor R_{Solution}. The capacitance of capillary wall 32 at each electrode 16A and 16B is represented by capacitor C_{Wall}, and is placed in series with each lead connection of AC signal source 12. This capacitance accounts for the capacitance of that portion of capillary wall 32 between electrode 16A or 16B and conductive solution L. As described hereinabove, capillary wall 32 is constructed from a non-conductive material such as silica glass. Capillary wall 32 is therefore a dielectric material which, rather than conducting current, can only allow electrical charges to accumulate on electrode 16A or 16B and in adjacent solution L. AC signal source 12 is also placed in parallel with a capacitor C_{Cylinder}. This circuit element accounts for both the direct capacitance of capillary wall 32 (i.e., electrode 16A through capillary wall 32 to electrode 16B) and the capacitance of capillary wall 32 plus that of solution L (i.e., electrode 16A through capillary wall 32 through solution L through capillary wall 12 to electrode 16B). Under most conditions, the magnitude of capacitor C_{Cylinder} will be negligible in comparison to the magnitude of capacitor C_{Wall}.

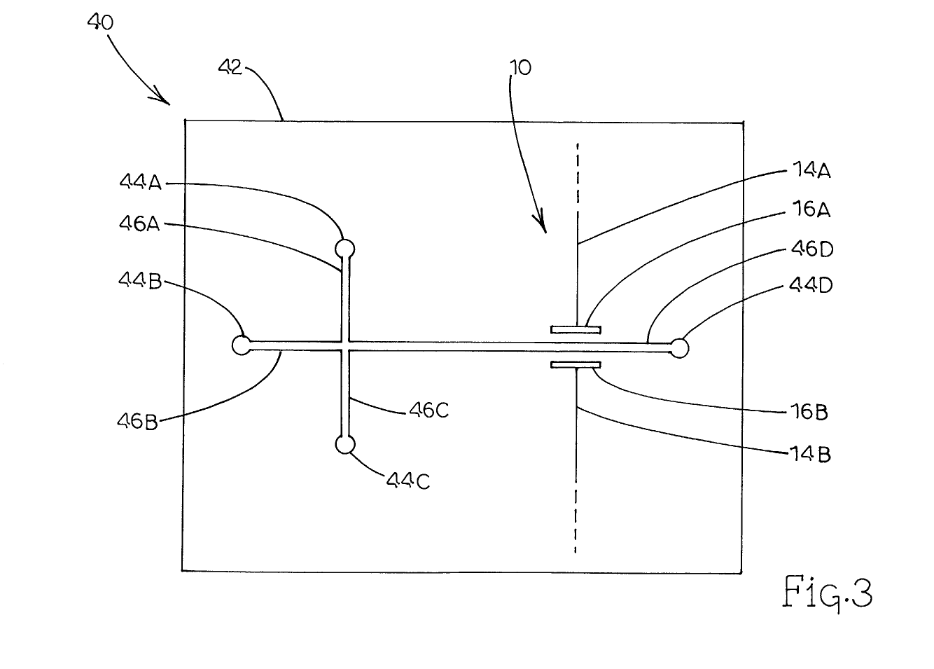

Referring now to FIG. 3, a simplified topology of a “lab-on-a-chip” device, generally designated 40, such as a microfluidic device, is illustrated. In accordance with this embodiment of the present invention, heating device 10 is integrated onto a substrate 42 of chip device 40. Chip device 40 and its associated components as described herein can be fabricated and assembled according to principles known to those skilled in the art. Chip device 40 could be provided in a form suitable for any number of applications that benefit from the use of a microfluidic-type device, such as chemical separations.

Substrate 42 represents either a full layer of chip device 40 or at least a region thereof. One or more reservoirs 44A-44D are formed on or in substrate 42 and are interconnected by fluid channels 46A-46D. In a non-limiting example, reservoir 44A receives and contains an analyte sample of interest, reservoir 44B receives and contains a solvent, reservoir 44C receives and collects waste, and reservoir 44D serves as either an end point or an fluid outlet from chip device 40. In this case, fluid channel 46D serves a function similar to that of fluid conduit or capillary 30 illustrated in FIGS. 1A and 1C. Additionally, electrodes 16A and 16B and their respective lead connections 14A and 14B, as part of heating device 10, are integrated onto substrate 42, either in the arrangement shown in FIG. 3 or in that shown in FIG. 1 (for clarity, AC signal source 12 is not specifically shown in FIG. 3). Contactless resistive heating device 10 can be activated to heat a targeted zone of liquid in fluid channel 46D according to principles and analogous methods described above. A highly miniaturized microfluidic device incorporating heating device 10 is thus provided.

One example of a useful application of heating device 10 involves performing the polymerase chain reaction (PCR) for amplifying specific DNA sequences, in a wide variety of applications such as medical diagnostics, forensics, and molecular biology. For a given DNA duplex structure consisting of two complementary strands, many copies of a target sequence can be obtained if the sequences of the flanking segments are known. As an example of a typical method for performing PCR, a solution containing the target sequence (i.e., the sequence to be amplified) is provided in vitro (such as in capillary 30 shown in FIGS. 1A-1C or in fluid channel 46D shown in FIG. 3). Oligonucleotides are synthesized for use as primers in the replication of the target DNA segment, and are added to the solution. Each of the synthetic oligonucleotide primers is complementary to a short sequence in one strand of the desired DNA segment and positioned just beyond the end of the sequence to be amplified, and is typically about 21 nucleotides in length. Deoxyribonucleoside triphosphates (dNTPs), as well as a magnesium component, are added to the solution. Also added is a thermostable DNA polymerase such as Taql.

In the present example, the two strands of the parent DNA molecule are denatured (i.e., separated) by heating the solution to approximately 90° C. for a suitable amount of time. The solution is then cooled to approximately 60° C. to allow each primer to hybridize to a respective DNA strand. DNA synthesis is then carried out by heating the solution to approximately 70° C. or 75° C. for a suitable amount of time, although the exact temperature will depend on the particular polymerase used. As a result, both strands of the target sequence are replicated. These three steps are driven by changing the temperature of the reaction mixture, and are cycled repetitively to produce new strands of DNA containing the target segment. All of the new DNA strands produced according to the method can serve as templates in successive cycles. The amount of template DNA that includes the target sequence flanked by the primers increases exponentially in subsequent cycles.

In accordance with the present invention, a method is therefore provided for performing the polymerase chain reaction, in which heating device 10 is employed to add heat to the solution during each denaturing step of each heating cycle. The use of heating device 10 to denature DNA molecules significantly shortens the overall time required to carry out the PCR process.

It should be noted that while heating device 10 is able to heat many types of liquids, one requirement for its successful operation is that the liquid to be heated be at least somewhat conductive. This is because the heating event is accomplished through the resistive drop of the applied AC current across the liquid. Fortunately, this is not a serious limitation in most forms of chromatography or in the PCR process just described.

It should be further noted that heating device 10 is not able to actually boil or vaporize liquids. This is because heating device 10 depends on current flow through the liquid in order to provide heat energy. Thus, when the liquid begins to boil, the current flow stops and causes the liquid to begin to cool back down. While in some cases this effect might constitute a disadvantage, in other cases it clearly is an advantage. For instance, in some applications such as denaturing proteins or DNA, a temperature near the boiling point of water is desired. With the use of conventional external heat sources, great care must be taken to heat the liquid near the boiling point without actually boiling the liquid. This difficultly is avoided with the use of heating device 10 of the present invention, as boiling is not possible.

### Flow Measuring Devices and Methods

In applicants' copending U.S. patent application Ser. No. 09/760,919, applicants disclosed the broad concept of providing and using a real-time flow meter or measuring device. This flow measuring device is characterized as providing several variations of a time-of-flight method. Each method disclosed in U.S. patent application Ser. No. 09/760,919 utilizes a perturbing element that produces a localized perturbing effect in a targeted zone of liquid, as well as a conductivity detection device for detecting a change in conductivity resulting from the perturbation or disturbance created by the perturbing element. In preferred embodiments, the conductivity detection device has a non-invasive, contactless design and is positioned downstream of the perturbing element.

One species of this flow measurement device is characterized in U.S. patent application Ser. No. 09/760,919 as performing an ionic concentration differential time-of-flight method. According to this method, the perturbing element is provided in the form of a phase changing element. The phase changing element is applied to a small section of a capillary or reservoir to rapidly change a portion of the liquid flowing therethrough into either the solid or gas phase, depending on whether the phase change element causes heat energy to be added to or rejected from the system containing the targeted zone of liquid. The solid or gas phase subsequently reverts back to the liquid phase. This rapid phase change causes ions to be displaced within the capillary. The conductivity detection device then senses a change in conductivity resulting from the displacement of ions in the liquid or solution flowing through the capillary.

Other species of the flow measurement device disclosed in U.S. patent application Ser. No. 09/760,919 are characterized as performing electrochemical and photochemical time-of-flight methods, respectively. In the electrochemical time-of-flight method, the perturbing element is provided in the form of one or more electrodes inserted directly into the capillary in contact with the solution. A discrete pulse of electrical energy supplied from an electrical source causes an electrochemical disturbance in a localized region or plug of the solution. This disturbance in turn causes a change in conductivity in the plug. As before, the conductivity detector is used to measure the conductivity in the plug, and thus the change in conductivity can be determined. In the photochemical time-of-flight method, the perturbing element is provided in the form of an electromagnetic energy source. Accordingly, a light source such as a laser is used to direct a pulse of focused light energy at the liquid plug to cause a photochemical disturbance. Again, the change in conductivity is detected by the conductivity detector.

A further species broadly disclosed in U.S. patent application Ser. No. 09/760,919 is characterized as performing a thermal time-of-flight method. In this embodiment, the perturbing element is provided in the form of a heating or cooling unit which, on a localized basis, adds heat to the liquid plug or removes heat from the liquid plug, but in either case does not transfer enough energy to effect a phase change in the liquid. The conductivity of the liquid is a function of temperature, and thus any temporary change in conductivity resulting from the heating or cooling pulse applied to the liquid plug can be rapidly detected by a conductivity detector.

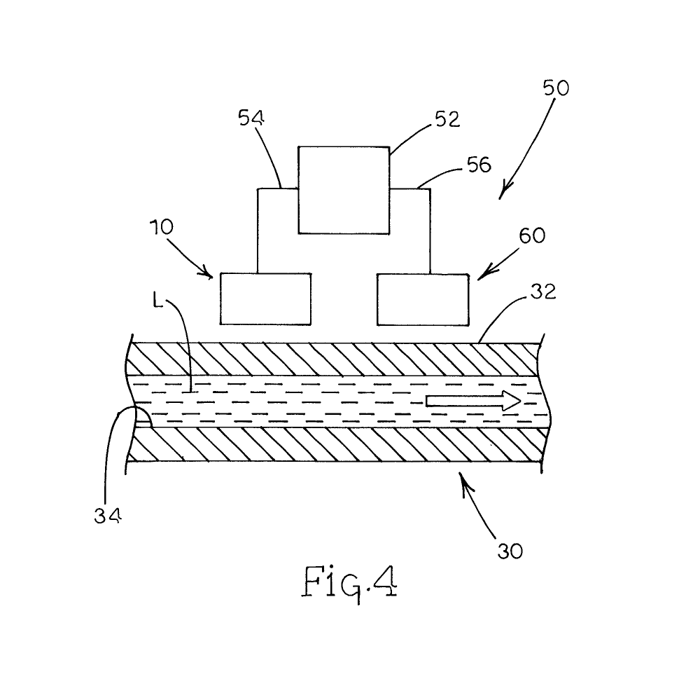

Referring now to FIG. 4, in accordance with another embodiment of the present invention, a contactless, real-time flow measuring apparatus, generally designated 50, is provided in which contactless resistive heating device 10 operates in conjunction with a conductivity detection device, generally designated 60. In this embodiment of flow measuring apparatus 50, heating device 10 serves as the perturbing element. Heating device 10 is thus utilized to non-invasively add heat energy to a targeted zone of flowing liquid L and thereby cause a rise in liquid temperature. As described above, the perturbation created by heating device 10 is related to the effect of the temperature rise in liquid L. This perturbation generally flows with liquid L for a period of time before dissipating or returning to equilibrium. Hence, the perturbation or its effect on liquid L can be detected through the proper positioning of conductivity detection device 60 downstream at a suitable distance from the point at which the perturbation is caused. The cooperation of heating device 10 and the conductivity detector 60 thus implements a thermal time-of-flight method for measuring the flow rate of liquid L.

Flow measuring apparatus 50 operates in conjunction with capillary 30. Liquid L flows through capillary core 34 defined by capillary wall 32. In FIG. 4, the direction of fluid flow is arbitrarily illustrated by the arrow as being from left to right. A computer or other electronic processing device 52 and any associated control and/or signal conditioning and amplification circuitry can be provided to communicate with both heating device 10 and conductivity detector 60 over electrical lines 54 and 56, respectively, and thus coordinate the timing of the respective functions of heating device 10 and conductivity detector 60.

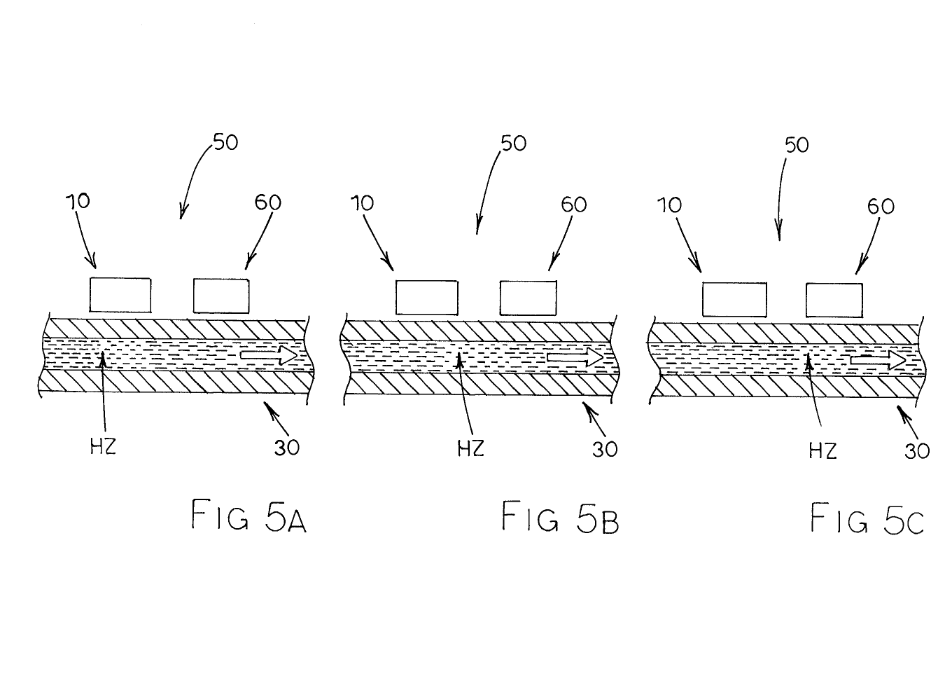

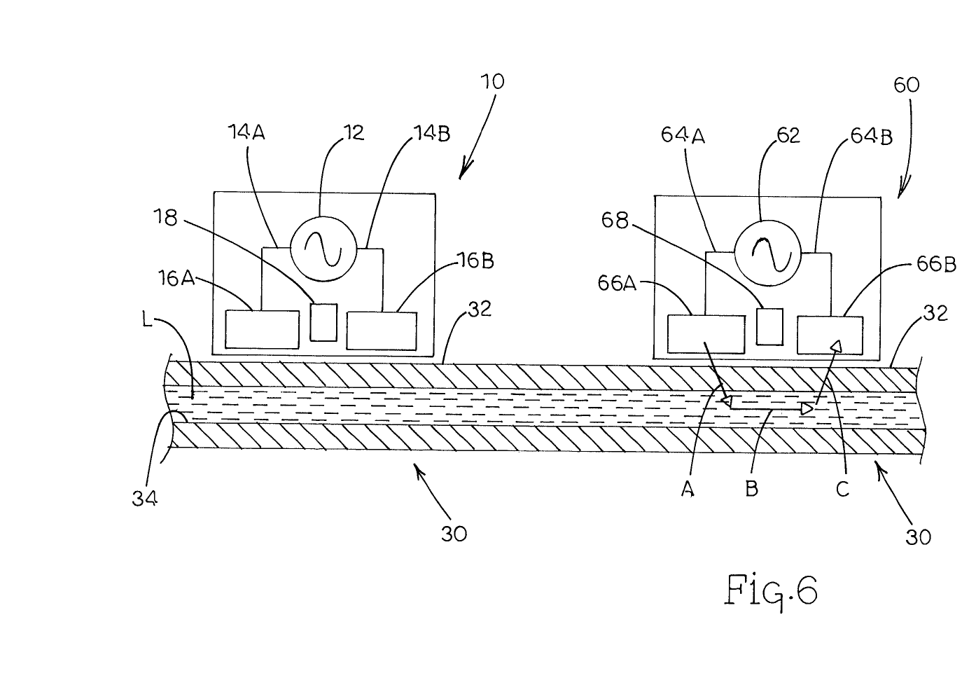

Referring to FIGS. 5A-5C, the operation of flow measuring apparatus 50 is illustrated schematically. The rapid heating of liquid L in capillary 30 creates a defined a zone or plug HZ of heated liquid, and thereby facilitates detection by conductivity detector 60 of the resulting change in conductivity. Due to the short section of capillary 30 involved in the heat application and the rapid heat transfer of small conduits, the increased temperature condition can be a short event which does not greatly affect other processes occurring in capillary 30. Indeed, it is preferable to heat liquid L for only a short amount of time in order to allow repeated measurements to be performed quickly.

Referring specifically to FIG. 5A, in order for flow measuring apparatus 50 to measure flow rate, heating device 10 is activated for a short amount of time to heat a small portion of liquid L flowing in capillary 30 and thereby create heated liquid zone HZ. Referring to FIG. 5B, heated liquid zone HZ continues to flow with the rest of liquid L through capillary 30 towards conductivity detector 60. Referring to FIG. 5C, heated liquid zone HZ reaches conductivity detector 60, which is activated after heating device 10 applies the heat energy to liquid L. This activation may be accomplished by providing a timer or clock (for example, using computer 52 in FIG. 4) that is initiated upon operation of heating device 10. When heated liquid zone HZ reaches conductivity detector 60 as shown in FIG. 5C, conductivity detector 60 detects the change in conductivity resulting from the increased temperature of heated liquid zone HZ. By accurately knowing the distance between heating device 10 and conductivity detector 60, the flow rate of liquid L can be calculated from the period of time the heated liquid zone HZ takes to traverse this distance.

Referring to FIG. 6, conductivity detector 60 preferably has a contactless design and thus, like heating device 10, is non-invasive with respect to liquid L or its conduit 30. Accordingly, the basic design of contactless conductivity detection device 60 can be made similar to that of contactless resistive heating device 10. Contactless conductivity detection device 60 thus includes an AC signal source 62 electrically coupled by lead wires 64A and 64B, respectively, to two electrodes 66A and 66B disposed in proximity to each other and mounted adjacent to the outside of capillary wall 32. Electrodes 66A and 66B are spaced at a distance from each other, and preferably are provided in the form of metallic bands or tubes which are coaxially disposed about capillary wall 32. A shield 68 is again preferably interposed between electrodes 66A and 66B to reduce their direct capacitive coupling to each other.

Contactless conductivity detection device 60 essentially functions analogously to heating device 10, insofar as conductivity detection device 60 applies an AC signal to electrodes 66A and 66B and capacitively couples the AC signal to liquid L across the dielectric material of capillary wall 32. The AC signal is capacitively coupled between electrode 66A and conductive liquid L in capillary core 34, as depicted by arrow A. A potential difference is established within capillary core 34 and causes a current to be conducted through liquid L in the direction generally represented by arrow B. When the current reaches the vicinity of other electrode 66B, the AC signal is capacitively coupled out as depicted by arrow C. Since the capacitance of capillary wall 32 remains fairly constant, the conductivity of liquid L between the two electrodes 66A and 66B is measured without direct contact or the need to perform modifications to capillary 30.

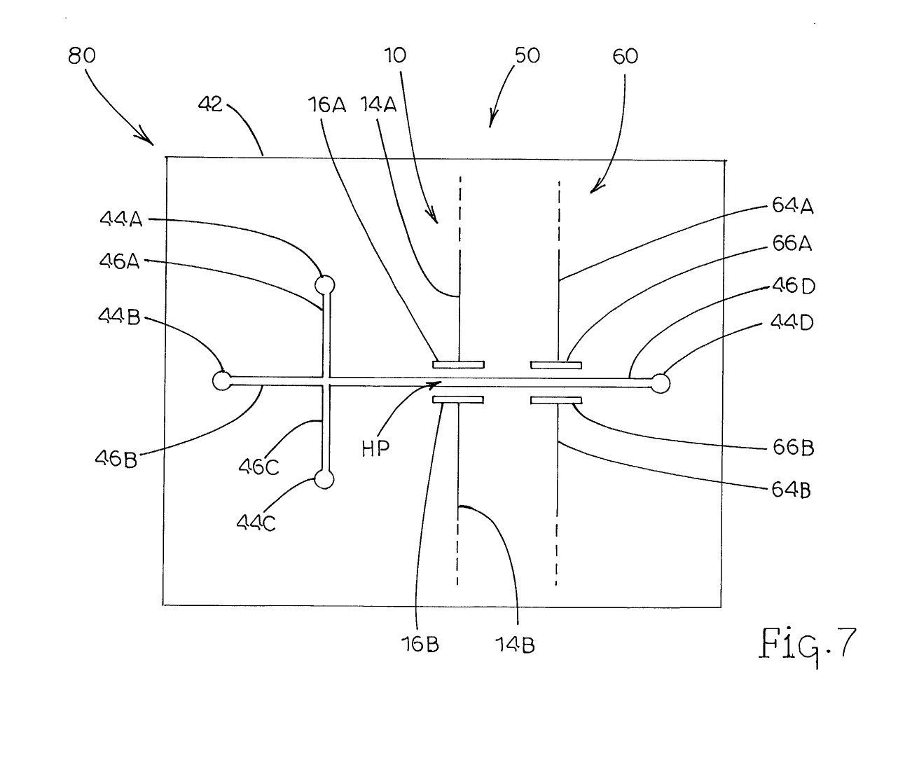

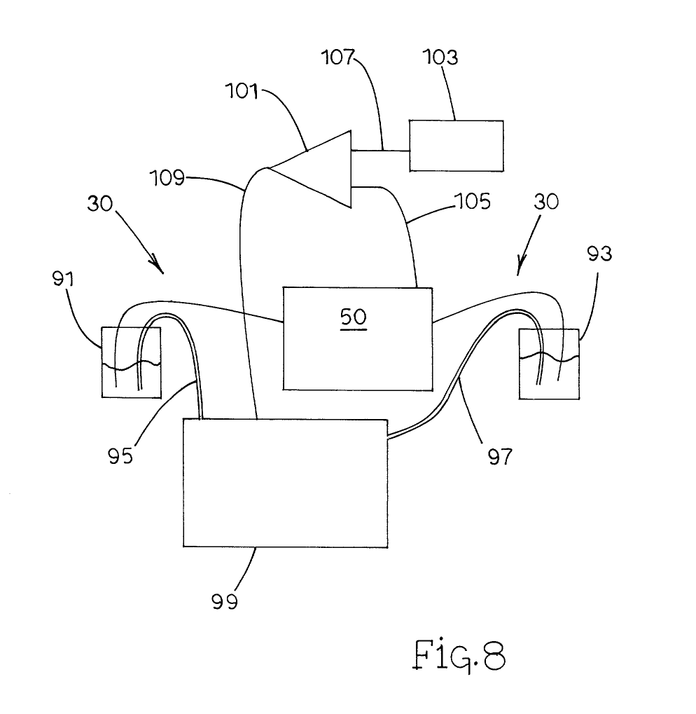

Referring to FIG. 7, a chip device, generally designated 80, such as a microfluidic device, is illustrated in accordance with a further embodiment of the present invention. Flow measuring apparatus 50 is integrated onto substrate 42 of chip device 80. Similar to the embodiment illustrated in FIG. 3, substrate 42 represents either a full layer of chip device 80 or at least a region thereof, and includes one or more reservoirs 44A-44D interconnected by fluid channels 46A-46D, all of which are formed on substrate 42 in the exemplary arrangement shown in FIG. 7. Flow measurement apparatus 50 functions similarly to the embodiment described with reference to FIGS. 4-6, and thus includes heating device 10 and conductivity detector 60 to provide a highly miniaturized liquid flow measuring device. Accordingly, heating device 10 includes electrodes 16A and 16B and their respecting lead connections 14A and 14B, and conductivity detector 60 includes electrodes 66A and 66B and their respecting lead connections 64A and 64B. Heating device 10 creates a heated liquid zone at a point of heat application generally designated HP. Conductivity detector 60 is then activated to detect the change in conductivity of the liquid flowing through flow channel 46D when the heated liquid zone reaches the detection area of conductivity detector 60.

Referring now to FIG. 8, flow measuring apparatus 50 can be implemented as a flow sensor for real-time control of liquid flow rate in any number of applications. In the specific, non-limiting example illustrated in FIG. 8, flow measuring apparatus 50 is utilized to monitor and control liquid flow rate during capillary electrophoresis (CE) runs. In the basic arrangement illustrated, capillary 30 runs from a buffer supply reservoir 91 or equivalent component, through flow measuring apparatus 50 including its associated components as described for the several embodiments hereinabove, and to a waste reservoir 93 or equivalent component. As understood by those skilled in the art of CE techniques, wires 95 and 97 run from a high-voltage power supply 99 to the solutions in reservoirs 91 and 93, respectively, to apply a voltage potential across capillary 30. Control of flow rate is enabled by providing a comparator 101 and associated circuitry, or its equivalent, and an interface 103 and associated circuitry for establishing a set point for the flow rate. Comparator 101 communicates with flow metering apparatus 50 over electrical line 105, with set point interface 103 over electrical line 107, and with power supply 99 over electrical line 109.

Flow measuring apparatus 50 monitors flow rate in capillary 30 according to one of the methods disclosed hereinabove, produces a signal indicative of the measured flow rate, and sends this signal to comparator 101. At predetermined time intervals, the signal for measured flow rate is compared to the set point signal received from set point interface 103. If the actual measured flow rate has deviated from the desired set point, an error or tolerance value is established in a manner known by those skilled in system control and circuit design, and a control signal is generated to make the adjustment needed to bring the actual flow rate back to the desired set point value. For instance, a control signal can be sent over electrical line 109 to power supply 99 to change the applied voltage and thus the flow rate. In other situations, a control signal would be provided to adjust fluid pressure or a pump or any other means by which liquid is caused to flow through capillary 30.

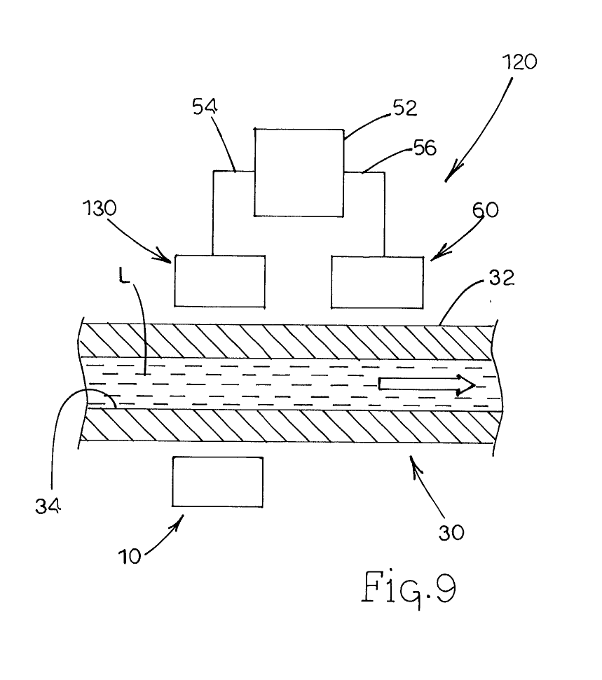

Referring now to FIG. 9, a non-limiting example is illustrated of a flow measuring apparatus, generally designated 120, according to an additional embodiment of the present invention. Flow measuring apparatus 120 is designed to non-invasively measure liquid flow rate in real-time inside of a capillary 30 (as defined hereinabove) by means of a localized perturbation caused by a phase change (in the present embodiment, freezing) in a targeted zone of liquid L flowing in capillary 30. Flow measurement apparatus 120 operates in accordance with the ionic concentration differential time-of flight method first disclosed in applicants' copending U.S. patent application Ser. No. 09/760,919 (which method is also generally described hereinabove). In U.S. patent application Ser. No. 09/760,919, applicants noted that in some cases it may not be desirable to permit the entire plug of liquid L to freeze if fluid flow becomes stopped for an excessive amount of time. It was therefore suggested that freezing of the entire plug could be prevented by adding a heating device to the flow measuring apparatus and/or by timing the operation of the freezing device more precisely. Accordingly, as specifically disclosed herein, heating device 10 according to the present invention can be provided to cooperate with the freezing device to prevent the entire plug from freezing and/or to assist in rapidly thawing the plug prior to the plug reaching the conductivity detection device.

As illustrated in FIG. 9, flow measuring apparatus 120 includes a perturbing element in the form of a phase changing device and, more specifically, a freezing or rapid cooling device, generally designated 130. Freezing device 130 can be any rapid cooling unit capable of causing at least partial solidification in a plug of liquid flowing through capillary 30. Non-limiting examples of suitable means for effecting rapid cooling include spraying refrigerated liquid, Joule-Thompson cooling, and using Peltier cooling devices. In applicants' copending U.S. patent application Ser. No. 09/760,919, an example is disclosed in which freezing device 130 comprises a vessel containing a supply of pressurized heat transfer fluid, a solenoid valve disposed in fluid communication with this vessel, and a heat transfer fluid ejection component such as a nozzle or orifice disposed in fluid communication with an output side of the solenoid valve. Actuation of the solenoid valve is controlled by an appropriate control signal fed over electrical line 54 from computer or electronic processing device 52. The ejection component is directed at a section of capillary 30 where the freezing is desired to occur. The operation of this particular cooling unit is based on the extremely fast expansion and evaporation of the initially compressed heat transfer fluid out of the ejection component, which causes a rapid rejection of heat energy out of liquid L in capillary 30 at the point of application according to known thermodynamic principles. In the broad context of the present invention, the exact freezing mechanism implemented is not important, so long as the freezing of liquid can be effected rapidly to a small section of capillary 30 and then be rapidly returned to the liquid phase.

Flow measuring device 120 further includes conductivity detection device 60, which preferably has the contactless design and function described previously. As in previously described embodiments, conductivity detection device 60 is disposed at a location downstream of the perturbing element, which in the present embodiment is freezing device 130. Additionally, heating device 10 is disposed at some point upstream of conductivity detector 60. The exact location of heating device 10 in the present embodiment is not important, so long as the targeted application of heat energy performed by heating device 10 causes a temperature rise in a portion of liquid surrounding or adjacent to the frozen plug of liquid. This heated portion prevents the frozen plug of liquid from completely stopping flow in capillary 30, and/or assists the plug in rapidly returning to the liquid phase prior to reaching conductivity detector 60. Computer or electronic processing device 52 and any associated control and/or signal conditioning and amplification circuitry can be provided to communicate with both freezing device 130 and conductivity detector 60 over electrical lines 54 and 56, respectively, and thus coordinate the timing of the respective functions of freezing device 130 and conductivity detector 60. Also not shown in FIG. 9 for clarity, electronic device 52 can also communicate with heating device 10 to control its operation as well.

In the present embodiment, flow measuring apparatus 120 measures liquid flow rate based on an ion displacement due to a temporary phase change (i.e., freezing) deliberately caused in liquid L flowing in capillary 30. The rapid cooling of liquid L in capillary 30 creates a sharp ionic concentration boundary in the heated or cooled liquid plug, and thereby facilitates detection by conductivity detector 60. Due to the short section of capillary 30 involved in the freezing operation and the rapid heat transfer of small conduits, the freezing can be a short event which does not greatly affect other processes occurring in capillary 30. It is preferable to cool liquid L for only a short amount of time in order to allow repeated measurements to be performed quickly.

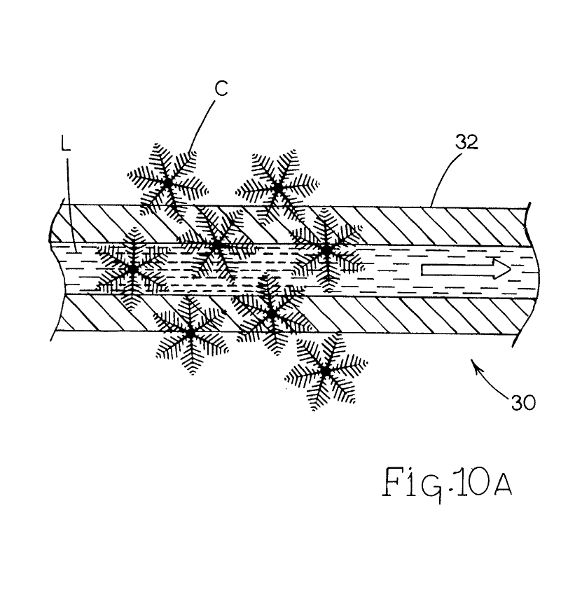

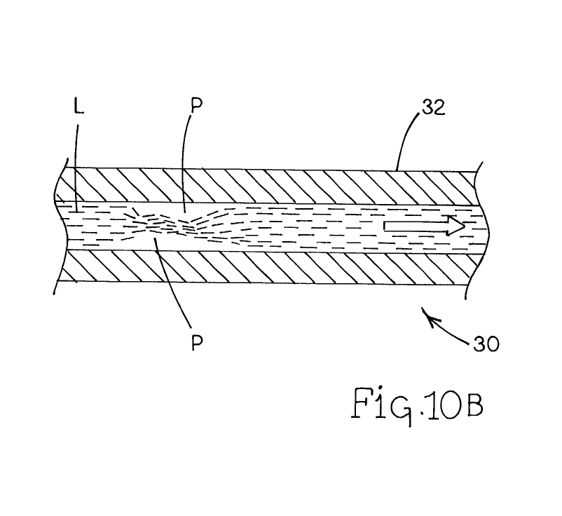

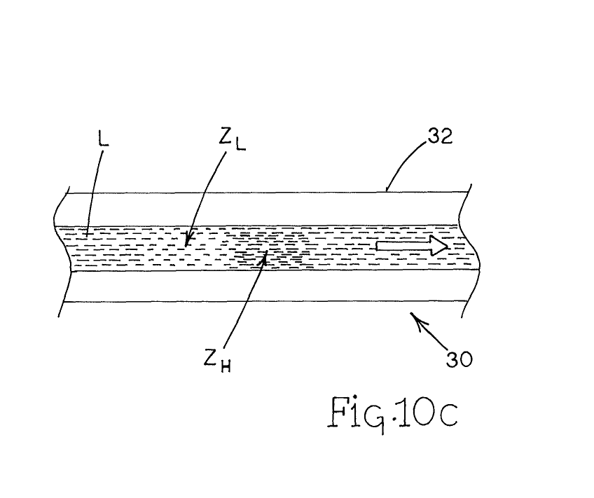

Referring to FIGS. 10A-10C, the effect of freezing device 130 is illustrated. Referring specifically to FIG. 10A, in order for flow measuring apparatus 120 to measure flow rate, freezing device 130 is activated for a short amount of time to freeze a small plug of liquid L flowing in capillary 30. In the specific embodiment illustrated, a burst of cold fluid C is applied to capillary 30. Referring to FIG. 10B, the liquid plug is subject to indirect thermal contact with the cold burst primarily through a combination of conductive and convective heat transfer modes. Consequently, at least a portion P of the liquid plug temporarily freezes into a solid phase. This phase change process displaces ions present in the liquid plug. Referring to FIG. 10C, the solid phase material melts soon thereafter, which in the present embodiment is assisted by activation of heating device 10 (see FIG. 9). The rapid phase change occurring during this process causes a region or zone of higher ionic concentration in solution L to form either before or after the liquid plug, and a region or zone of lower ionic concentration generally within the central vicinity of the liquid plug itself. In FIG. 10C, the region of lower ionic concentration is generally designated Z_{L} and the region of higher ionic concentration is generally designated Z_{H}. It is believed at the present time that salts are separated out from the liquid plug and lead to the creation of zone of higher ionic concentration Z_{H}.

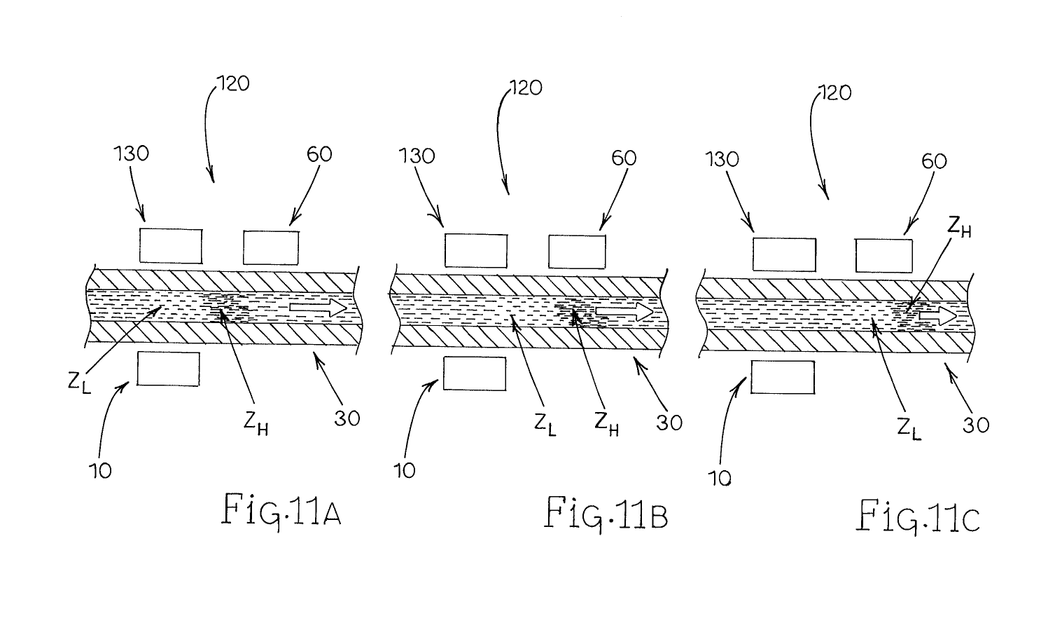

Referring to FIG. 11A, contactless conductivity detection device 60, having first been positioned downstream of freezing device 130, is activated after the phase change occurs. This activation may be accomplished by providing a timer or clock (for example, using computer 52 in FIG. 9) that is initiated upon operation of freezing device 130. As shown in FIG. 11B, zones of higher and lower ionic concentration Z_{H} and Z_{L}, respectively, associated with the thawed (or thawing) liquid plug continue to flow through capillary 30 toward conductivity detector 60. Due to the regions of higher and lower ionic strength now residing in capillary 30, when these regions reach conductivity detector 60 as shown in FIG. 11C, conductivity detector 60 can detect the change in conductivity resulting from this ionic strength differential. By accurately knowing the distance between freezing device 130 and conductivity detector 60, the flow rate of liquid L can be calculated from the period of time the differing ionic regions take to traverse this distance.

It should be noted that because the inventive technique described hereinabove is based on detecting a plug of solvent having a different ionic strength than that of the balance of the solvent, ions must be present in the solvent. If, for instance, the solvent is de-ionized water or a non-polar organic liquid, then there would not be enough ions present to detect the small change that the inventive flow sensor detects. The solvent must also contain a component that is either easily vaporized or frozen in order to create a plug of different ionic strength. The present invention has been successfully practiced in conjunction with aqueous solvents with different ions and additives, which solvents are used in approximately ninety percent of the chromatography procedures performed.

It should also be noted that the inventive technique requires that the liquid in the capillary undergo a phase change from liquid to solid and then back to liquid. As discussed previously, heating device 10 is not itself capable of effecting a phase change. However, it is presently believed that heating device 10 is capable of sensibly heating the liquid proximate to the plug that is being cooled by, or that has been frozen by, freezing device 130. Thus, the change in sensible heat in the liquid causes a rise in temperature in the liquid, which in turn establishes a temperature gradient between the liquid heated by heating device 10 and the plug of liquid frozen by freezing device 130. Additionally, or alternatively, it is presently believed that the frozen portion of the plug acts as a temporary dielectric component, thereby serving as an additional capacitor in the circuit formed with AC signal source 12 of heating device 10. It could thus be concluded that heating occurs in the liquid adjacent to both sides of the frozen plug. In either case, heating device 10 operates to assist in controlling the degree of freezing occasioned by freezing device 130 and/or causing the frozen plug to melt back into the liquid phase.

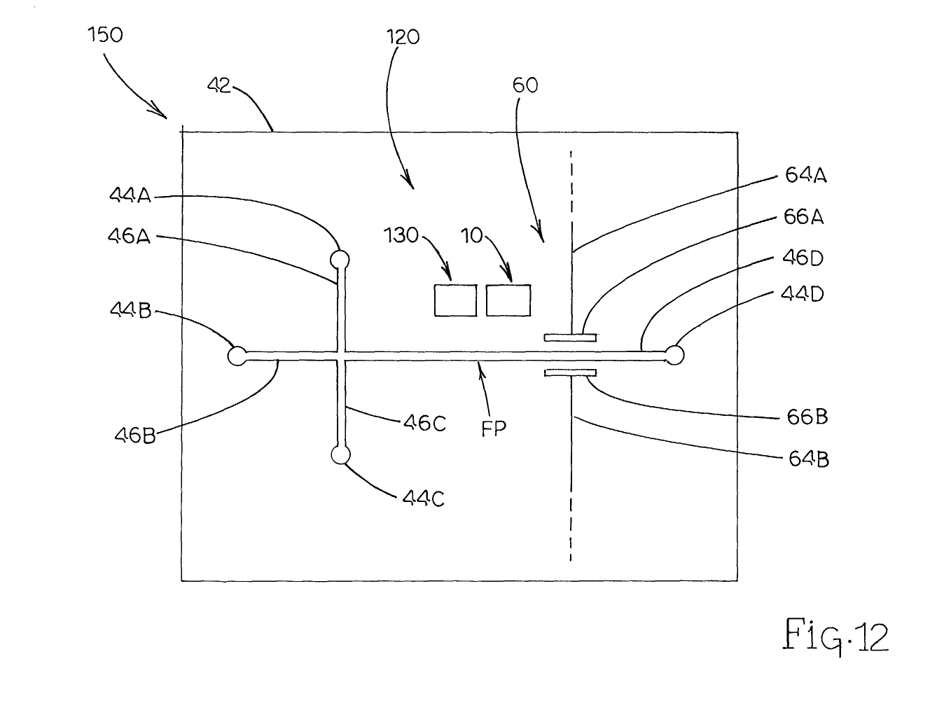

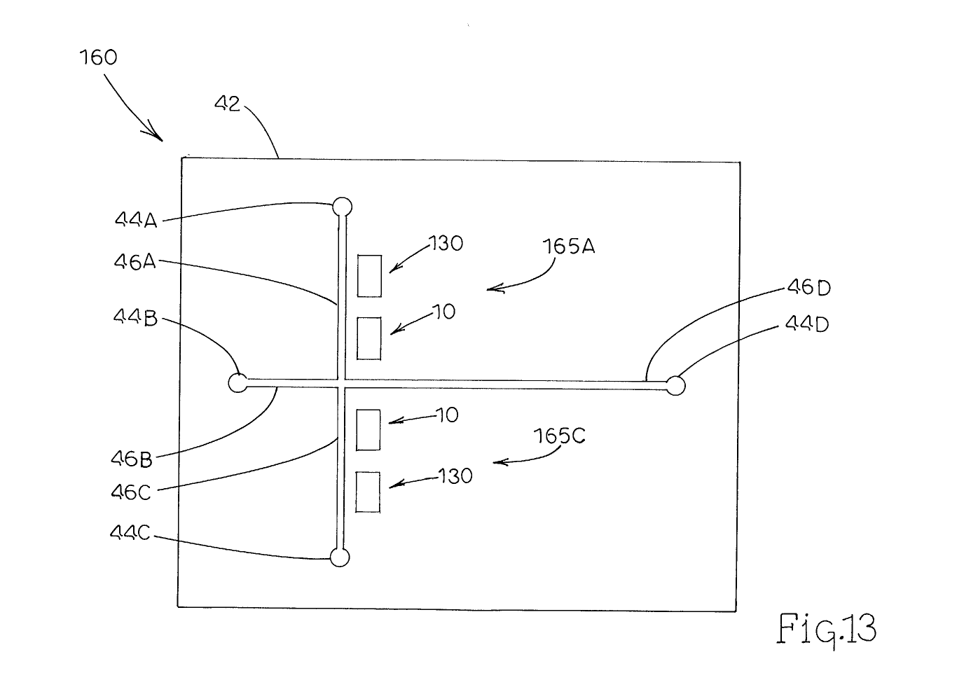

Referring to FIG. 12, another embodiment of a chip device, generally designated 150, such as a microfluidic device, is illustrated. In accordance with this embodiment of the present invention, flow measuring apparatus 120 is integrated onto substrate 42 of chip device. Similar to previously described embodiments, substrate 42 represents either a full layer of chip device 150 or at least a region thereof, and includes one or more reservoirs 44A-44D interconnected by fluid channels 46A-46D, all of which are formed on substrate 42. Flow measurement apparatus 120 functions similarly to the embodiment described with reference to FIGS. 9-11, and thus includes heating device 10, freezing device 130 and conductivity detector 60 to provide a highly miniaturized liquid flow measuring device. Freezing device 130 creates a frozen zone or plug of liquid at freezing point FP. Heating device 10 is then activated to add heat to fluid channel 46D in the area of the frozen plug to rapidly return the frozen plug back to the liquid phase. Conductivity detector 60 is then activated to detect the change in conductivity of the liquid flowing through fluid channel 46D when the cooled liquid plug reaches the detection area of conductivity detector 60.

In accordance with another embodiment of the present invention, flow measuring apparatus 120 can be implemented as a flow sensor for real-time control of liquid flow rate in any number of applications. One specific, non-limiting example is illustrated in FIG. 8, where it will be understood that flow measuring apparatus 120 is substituted for flow measuring apparatus 50, for use in monitoring and controlling liquid flow rate during capillary electrophoresis (CE) runs.

### Liquid Flow Control in Microenvironments

Referring now to FIG. 13, a microfluidic chip device, generally designated 160, is illustrated according to a further embodiment of the present invention. One or more inlets, outlets or reservoirs 44A-44D are interconnected by fluid channels 46A-46D, all of which are formed on substrate 42 of chip device 160. In order to control liquid flow through one of more of fluid channels 46A-46D, such as fluid channels 46A and 46C in FIG. 13, chip device 160 includes one or more phase-changing switching devices or gates, generally designated 165A (controlling liquid flow through fluid channel 46A) and 165C (controlling liquid flow through fluid channel 46C). Switching devices 165A and 165C respectively operate, in response to control signals or other suitable excitation, to alternatively freeze and thaw the liquid flowing through the localized zones or switching points in fluid channels 46A and 46C targeted by switching devices 165A and 165C. For this purpose, each switching devices 165A and 165C includes heater device 10 and freezing device 130. Heating device 10 and freezing device 130 are configured in accordance with any of the embodiments disclosed herein.

As an example of the operation of switching device 165A, freezing device 130 is activated to causing rapid freezing in the target zone within fluid channel 46A, thereby preventing liquid flow through fluid channel 46A. In order to resume flow, freezing device 130 is deactivated to allow the frozen portion of liquid in the targeted zone to thaw. Heating device 10 can be activated at this time to assist and accelerate the thawing process. It will be understood that several such switching devices can be operatively associated with several different fluid channels and/or reservoirs contained on a microfluidic device such as chip device 160 so that, under an appropriate control regime, many different liquid flow circuits can be created very quickly throughout the microfluidic device to serve a variety of purposes.

The embodiment illustrated in FIG. 13 is not limited to the scale of microfluidic devices. Switching device 165A can operate to alternately prevent and permit liquid flow through conduits of greater dimensions, so long as sufficient electrical power is provided to enable heating device 10 to assist in heating the liquid adjacent to the frozen plug. It can be further appreciated that heating device 10 can operate in conjunction with freezing device 130 to control the amount of freezing occurring at the target zone. In this manner, the effective flow diameter through the target zone can be controlled, such that switching device 165A could be characterized as a “liquid valve” that alters the flow characteristics through the targeted zone. In accordance with the present invention, the activity of both heating device 10 and freezing device 130 could be monitored and controlled, in further cooperation with a flow measuring device as disclosed herein, in order to precisely and non-invasively tailor the flow rate through the zone targeted by switching device 165A.

It will be understood that various details of the invention may be changed without departing from the scope of the invention. Furthermore, the foregoing description is for the purpose of illustration only, and not for the purpose of limitation—the invention being defined by the claims.

What is claimed is:

1. A contactless resistive heating device comprising:
(a) a substantially non-conductive substrate containing a liquid;
(b) an AC signal source; and
(c) at least two electrodes disposed externally in relation to the substrate and spaced at a distance from each other, each electrode electrically communicating with the AC signal source, wherein application of an AC signal to the electrodes by the AC signal source capacitively couples the AC signal source with the liquid contained by the substrate, and causes an electrical current to flow in a zone of the liquid generally disposed between the electrodes.

2. The heating device according to claim 1 wherein the substrate is constructed from a fused silica material.

3. The heating device according to claim 1 wherein the substrate is constructed from a polymeric material.

4. The heating device according to claim 1 wherein the substrate includes a conduit wall.

5. The heating device according to claim 4 wherein the conduit wall has an inside diameter of approximately 1 mm or less.

6. The heating device according to claim 5 wherein the conduit wall has an inside diameter of approximately 0.2 mm or less.

7. The heating device according to claim 6 wherein the conduit wall has an inside diameter of approximately 0.05 mm or less.

8. The heating device according to claim 1 wherein at least one of the electrodes includes a metal band disposed coaxially about the substrate.

9. The heating device according to claim 1 comprising an electrically isolating shield disposed between the two electrodes.

10. The heating device according to claim 1 comprising a control device communicating with the AC signal source and adapted to control an amplitude of an AC signal provided by the AC signal source to the electrodes.

11. A microfluidic device adapted to heat a small zone of liquid contained in a fluid channel, the microfluidic device comprising:
(a) a substrate;
(b) a fluid channel containing a liquid, the fluid channel formed on the substrate and including a substantially non-conductive wall;
(c) an AC signal source; and
(d) at least two electrodes disposed externally in relation to the fluid channel and spaced at a distance from each other, each electrode electrically communicating with the AC signal source, wherein the AC signal source is capacitively coupled with the liquid contained by the fluid channel, and wherein application of an AC signal to the electrodes by the AC signal source causes an electrical current to flow in a zone of the liquid generally disposed between the electrodes.

12. The heating device according to claim 11 comprising a control device communicating with the AC signal source and adapted to control an amplitude of an AC signal provided by the AC signal source to the electrodes.

13. A method for non-invasively, resistively heating a targeted zone of liquid contained by a substrate, comprising the steps of:
(a) placing at least a first electrode and a second electrode externally in relation to a substrate containing a liquid, wherein the first and second electrodes are axially spaced apart from each other in relation to a length of the substrate, and whereby a zone of the liquid is generally defined between the first and second electrodes; and
(b) heating the zone of liquid by applying an AC signal to the first and second electrodes, whereby the AC signal is capacitively coupled from the first electrode into the liquid, an electrical current flows through the zone of liquid, and the AC signal is capacitively coupled out from the liquid to the second electrode.

14. The method according to claim 13 comprising the step of controlling the amount of heating of the zone of liquid by controlling an amplitude of the AC signal applied to the first and second electrodes.

15. A method for performing a polymerase chain reaction comprising the steps of:
(a) providing a liquid comprising double-stranded DNA, oligonucleotide primers, nucleotide triphosphates, magnesium, and a DNA polymerase contained by a substantially non-conductive substrate; and
(b) using a contactless resistive heating device to raise a temperature in a zone of the liquid containing the DNA.

16. The method according to claim 15 wherein the step of using the heating device to raise the temperature includes:
(a) providing an AC signal source and at least two electrodes disposed externally in relation to the substrate, wherein each electrode is spaced at a distance from the other electrode and electrically communicates with the AC signal source, and wherein the zone of liquid is generally disposed between the two electrodes; and
(b) causing the AC signal source to apply an AC signal to the electrodes, whereby the AC signal becomes capacitively coupled with the liquid contained by the substrate, an electrical current flows through the zone of liquid, and the zone of liquid becomes heated to a denaturing temperature.

17. The method according to claim 15 wherein the heating device is used to raise a denaturing temperature of a magnitude sufficient to separate the double-stranded DNA into separate DNA strands.

18. The method according to claim 15 comprising the step of controlling a value of the temperature in the zone of liquid by controlling an amount of AC power transferred from the heating device.

19. A method for performing a polymerase chain reaction comprising the steps of:
(a) providing a liquid comprising double-stranded DNA, oligonucleotide primers, nucleotide triphosphates, magnesium, and a DNA polymerase contained by a substantially non-conductive substrate;
(b) providing a contactless resistive heating device including an AC signal source and at least two electrodes disposed externally in relation to the substrate, wherein each electrode is spaced at a distance from the other electrode and electrically communicates with the AC signal source;
(c) denaturing the double-stranded DNA to generate single-stranded DNA by causing the AC signal source to apply an AC signal to the electrodes, whereby the AC signal becomes capacitively coupled with the liquid contained by the substrate, an electrical current flows in a zone of the liquid generally disposed between the electrodes and containing the DNA, and the zone becomes heated to a denaturing temperature;
(d) adjusting the temperature of the liquid to permit hybridization of the primers;
(e) adjusting the temperature of the liquid to a extending temperature sufficient to permit extension of the primers by the DNA polymerase; and
(f) repeating steps (b)-(d) a desired number of times.

20. The method according to claim 19 comprising the step of controlling an amount of heat energy applied by the heating device to the zone of liquid by controlling an amplitude of the AC signal applied to the electrodes.

21. The method according to 19 wherein the heating device is used to adjust the temperature of the liquid to the extending temperature.

22. A method for performing a polymerase chain reaction comprising the steps of:
(a) providing a liquid comprising double-stranded DNA, oligonucleotide primers, nucleotide triphosphates, magnesium and a DNA polymerase contained by a non-conductive substrate;
(b) denaturing the double-stranded DNA to generate single-stranded DNA by capacitively coupling an AC signal with the liquid, whereby an electrical current flows through the liquid and the liquid becomes heated to a denaturing temperature;
(c) adjusting the temperature of the liquid to permit hybridization of the primers;
(d) adjusting the temperature of the liquid to a extending temperature sufficient to permit extension of the primers by the DNA polymerase; and
(e) repeating steps (b)-(d) a desired number of times.

23. The method according to claim 22 comprising the step of controlling an amount of heat energy applied by the heating device to the zone of liquid by controlling an amplitude of the AC signal capacitively coupled with the liquid.

24. The method according to 22 wherein the heating device is used to adjust the temperature of the liquid to the extending temperature.

25. A liquid flow measuring apparatus comprising:
(a) a fluid conduit including a substantially non-conductive conduit wall;
(b) a contactless resistive heating device adapted to raise a temperature of a zone of liquid flowing through the fluid conduit; and
(c) a conductivity detection device disposed downstream of the heating device in relation to the conduit wall.

26. The apparatus according to claim 25 wherein the heating device includes an AC signal source and first and second electrodes connected to the AC signal source, wherein the first and second electrodes are disposed externally in relation to the conduit wall and are spaced from each other.

27. The apparatus according to claim 26 wherein the AC signal source is capacitively coupled with the liquid flowing through the fluid conduit, and wherein application of an AC voltage to the electrodes by the AC signal source causes an electrical current to flow in a zone of the liquid generally disposed between the electrodes.

28. The apparatus according to claim 26 comprising a control device communicating with the AC signal source and adapted to control an amplitude of an AC signal provided by the AC signal source to the electrodes.

29. The apparatus according to claim 25 wherein:
(a) the heating device includes a first AC signal source and first set of electrodes connected to the first AC signal source, and the first set of electrodes are disposed externally in relation to the conduit wall and are spaced from each other; and
(b) the conductivity detection device includes a second AC signal source and second set of electrodes connected to the second AC signal source, and the second set of electrodes are disposed externally in relation to the conduit wall and are spaced from each other.

30. The apparatus according to claim 25 comprising an electronic control device electrically communicating with the heating device and the conductivity detection device and adapted to control respective operations of the heating device and the conductivity detection device.

31. The apparatus according to claim 25 wherein the conductivity detection device is a contactless conductivity detection device.

32. The apparatus according to claim 31 wherein the conductivity detection device includes an AC signal source and first and second electrodes connected to the AC signal source, wherein the first and second electrodes are disposed externally in relation to the conduit wall and are axially spaced from each other.

33. The apparatus according to claim 25 comprising a rapid cooling device disposed upstream of the conductivity detection device and adapted to freeze at least a portion of the zone of liquid.

34. The apparatus according to claim 33 comprising a comparator device electrically communicating with the conductivity detection device and adapted to compare a value indicative of measured flow rate with a value indicative of preset flow rate, and a flow rate adjustment device operatively communicating with the comparator device.

35. The apparatus according to claim 25 comprising a comparator device electrically communicating with the conductivity detection device and adapted to compare a value indicative of measured flow rate with a value indicative of preset flow rate, and a flow rate adjustment device operatively communicating with the comparator device.

36. A liquid flow measuring apparatus comprising:
(a) a fluid conduit including a substantially non-conductive conduit wall;
(b) a contactless resistive heating device adapted to raise a temperature of a zone of liquid flowing through the fluid conduit, the heating device including an AC signal source and first and second electrodes connected to the AC signal source, wherein the first and second electrodes are disposed externally in relation to the conduit wall and are spaced from each other; and
(c) a conductivity detection device disposed downstream of the heating device in relation to the conduit wall.

37. The apparatus according to claim 36 wherein the AC signal source is capacitively coupled with the liquid flowing through the fluid conduit, and wherein application of an AC signal to the electrodes by the AC signal source causes an electrical current to flow in a zone of the liquid generally disposed between the electrodes.

38. A microfluidic device adapted to measure liquid flow rates, the microfluidic device comprising:
(a) a substrate;
(b) a fluid channel containing a liquid, the fluid channel formed on the substrate and including a substantially non-conductive wall;
(c) a contactless resistive heating device adapted to raise a temperature of a zone of liquid flowing through a section of the fluid channel; and
(d) a conductivity detection device disposed downstream of the section of the fluid conduit at which the liquid temperature is raised.

39. The microfluidic device according to claim 38 wherein the heating device includes an AC signal source and at least two electrodes disposed externally in relation to the fluid channel and spaced at a distance from each other, each electrode electrically communicating with the AC signal source, wherein the AC signal source is capacitively coupled with the liquid contained by the fluid channel, and wherein application of an AC signal to the electrodes by the AC signal source causes an electrical current to flow in the zone of the liquid flowing through the section of the fluid channel.

40. A method for measuring the rate at which a liquid is flowing through a fluid conduit comprising the steps of:
(a) conducting a liquid through a fluid conduit, the fluid conduit including a substantially non-conductive wall;
(b) using a contactless, resistive heating device to cause a temperature rise in a volume of the liquid disposed in a first section of the fluid conduit; and
(c) at a second section of the fluid conduit spaced downstream of the first section at a predetermined distance, detecting a change in conductivity in the liquid occurring as a result of the temperature rise.

41. The method according to claim 40 wherein the step of using the heating device to cause a temperature rise includes:
(a) placing at least a first electrode and a second electrode externally in relation to the fluid conduit, wherein the first and second electrodes are spaced apart from each other in relation to a length of the fluid conduit, and whereby the volume of liquid is generally defined between the first and second electrodes; and
(b) heating the volume of liquid by applying an AC signal to the first and second electrodes, whereby the AC signal is capacitively coupled from the first electrode into the liquid, an electrical current flows through the volume of liquid, and the AC signal is capacitively coupled out from the liquid to the second electrode.

42. A liquid flow measuring apparatus including:
(a) a fluid conduit including a substantially non-conductive conduit wall;
(b) a rapid cooling device adapted to freeze a first portion of a liquid flowing through the fluid conduit;
(c) a contactless resistive heating device adapted to add heat energy to a second portion of the liquid proximate to the first portion of the liquid;
(d) a conductivity detection device disposed downstream of the rapid cooling device in relation to the conduit wall.

43. The apparatus according to claim 42 wherein the heating device includes an AC signal source and first and second electrodes connected to the AC signal source, and the first and second electrodes are disposed externally in relation to the conduit wall and are spaced from each other.

44. A method for measuring the rate at which a liquid is flowing through a fluid conduit comprising the steps of:
(a) conducting a liquid through a fluid conduit, the fluid conduit including a substantially non-conductive wall;
(b) using a rapid cooling device to freeze at least a portion of a volume of the liquid disposed in a first section of the fluid conduit;
(c) using a contactless, resistive heating device to assist in thawing the portion of liquid subject to freezing by the rapid cooling device; and
(d) at a second section of the fluid conduit spaced downstream of the first section at a predetermined distance, detecting a change in conductivity in the liquid occurring as a result of the use of at least the rapid cooling device.

45. The method according to claim 44 wherein the step of using the heating device includes:
(a) placing at least a first electrode and a second electrode externally in relation to the fluid conduit, wherein the first and second electrodes are spaced apart from each other in relation to a length of the fluid conduit, and whereby a zone of the liquid to be heated is generally defined between the first and second electrodes; and
(b) heating the zone of liquid by applying an AC signal to the first and second electrodes, whereby the AC signal is capacitively coupled from the first electrode into the liquid, an electrical current flows through the zone of liquid, and the AC signal is capacitively coupled out from the liquid to the second electrode.

46. A device for controlling liquid flow through a conduit, the device comprising:
(a) a fluid conduit including a substantially non-conductive conduit wall;
(b) a freezing device adapted to freeze a first portion of a liquid contained in the fluid conduit; and
(c) a contactless resistive heating device adapted to raise a temperature of a second portion of liquid contained in the fluid conduit.

47. A method for controlling liquid flow through a conduit comprising the steps of:
(a) stopping a flow of liquid through a targeted section of a fluid conduit having a non-conductive conduit wall by freezing a first portion of the liquid contained in the targeted section; and
(b) permitting liquid to flow through the targeted section by activating a contactless resistive heating device, whereby the heating device causes a rise in temperature in a second portion of the liquid adjacent to the frozen first portion, and thereby assists in thawing the frozen portion.
